(19) United States
(12) Patent Application Publication
(10) Pub. No.: US 2004/0169853 A1
(43) Pub. Date: Sep. 2, 2004

(54) Surface inspection apparatus

(76) Inventors: Yoichiro Iwa, Tokyo-to (JP); Kazuhiro Miyakawa, Tokyo-to (JP); Akihiko Sekine, Tokyo-to (JP)

Correspondence Address: Kevin S. Lemack, Nields & Lemack, Suite 7, 176 E. Main Street, Westboro, MA, 01581, US

(21) Appl. No.: 10/775,684

(22) Filed: Feb. 10, 2004

(30) Foreign Application Priority Data
Feb. 18, 2003 (JP) JP2003-039704
Jan. 23, 2004 (JP) JP2004-015576

(51) Int. Cl. G01N 21/88

(52) U.S. Cl. 356/237.3

(57) ABSTRACT

A surface inspection apparatus for detecting foreign matter and the like on a surface of a substrate by projecting and scanning laser beams to the surface of the substrate, comprising a light source unit for projecting two or more laser beams, and a projecting optical system for converging the laser beams so that the two or more laser beams are aligned in a row in a direction perpendicularly crossing the scanning direction at a projecting point on the substrate.

### BACKGROUND OF THE INVENTION

The present invention relates to a surface inspection apparatus for inspecting very small foreign matter or micro-size flaws such as crystal defects on a surface of a substrate such as a semiconductor wafer.

As a surface inspection apparatus for inspecting very small foreign matter or micro-size flaws such as crystal defects on a surface of a substrate, a type of surface inspection apparatus using a laser beam is known. In such type of surface inspection apparatus, a laser beam is converged and projected to a surface of a substrate so that a projecting point of the laser beam scans over the entire surface of the substrate. Then, the scattered light generated by foreign matter, flaws, etc. are detected. The intensity and the duration of the scattered light are analyzed, and foreign matter, flaws, etc. are identified.

As a light emitting source of the surface inspection apparatus, gas laser (such as He—Ne, Ar, etc.) has been generally used. In recent years, however, a laser diode (LD) is frequently used from the reasons such as easiness to handle, safety, long service life, etc.

FIG. 8 shows a conventional type surface inspection apparatus 1, which uses a laser diode as the light emitting source.

In the figure, reference numeral 2 denotes a substrate such as a wafer to be inspected. The surface inspection apparatus 1 primarily comprises a scan driving mechanism 3, a projecting optical system 4, and a detection system 5.

The scan driving mechanism 3 comprises a substrate holding unit 6 for holding the substrate 2. The substrate holding unit 6 is rotatably supported by a rotary driving unit 7. It is designed in such manner that the rotary driving unit 7 is linearly moved in a radial direction in parallel to a rotating surface of the substrate 2 by a linear driving mechanism 8.

The projecting optical system 4 comprises a light source unit 10 for emitting a laser beam 9 as an inspection light beam, deflecting optical members 11 and 12 such as mirrors for deflecting the laser beam 9 from the light source unit 10 onto the substrate 2, and a group of lenses 13 for converging the laser beam 9 to the surface of the substrate 2. The detection system 5 comprises a photodetector, which has a detection optical axis crossing an optical axis of the laser beam 9 projected to the surface of the substrate 2. Here, as an example, it is assumed that the detection system 5 comprises two photodetectors 14a and 14b, which are arranged in directions different from each other. As the photodetectors 14a and 14b, photomultiplier tubes, etc. are used, and the received scattered light is converted by photoelectric conversion.

After being projected from the light source unit 10, the laser beam 9 is deflected by the deflecting optical members 11 and 12 so that the laser beam is projected to a projecting point at a predetermined position on the substrate 2, and the laser beam 9 is converged to the projecting point by the lens group 13.

In the surface inspection of the substrate 2, under the condition that the substrate 2 is rotated by the rotary driving unit 7, the laser beam 9 is projected to the surface of the substrate 2 by the projecting optical system 4. Further, the rotary driving unit 7 is moved in the radial direction by the linear driving mechanism 8.

By the linear driving mechanism 8, the rotary driving unit 7 is moved step by step with a predetermined pitch for each turn of the substrate 2, or the rotary driving unit 7 is moved continuously at a predetermined speed. Then a projecting point (spot) of the laser beam 9 is moved to the outer edge from the center of the substrate 2 by following concentric or spiral locus, and the entire surface of the substrate 2 is scanned by the laser beam 9.

During a process when the surface of the substrate 2 is scanned by the laser beam 9, if there are foreign matter or flaws on the surface, the laser beam 9 is scattered. The scattered light is detected by the photodetectors 14a and 14b of the detection system 5, which are arranged at predetermined positions. The photodetectors 14a and 14b convert the scattered light to an electric signal by photoelectric conversion, and the electric signal is sent to an arithmetic processor (not shown). The arithmetic processor processes the signal from the photodetectors 14a and 14b by processing means such as analysis, and number and size of the foreign matter or flaws are detected.

In the surface inspection apparatus 1 as described above, the scanning pitch varies according to a combination of rotating speed of the substrate 2 and feeding speed of the linear driving mechanism 8. Therefore, when the rotating speed of the substrate 2 is set to a constant value, inspection time is shortened if the scanning pitch is increased. If the scanning pitch is decreased, the inspection time will be longer. Further, a light amount of the scattered light depends on the size of the foreign matter and also on light intensity of the projected laser beam 9. That is, in general, the higher the light intensity is, the more the light amount of the scattered light is increased, and the larger the foreign matter are, the higher the light amount of the scattered light is.

FIG. 9 is a diagram showing light intensity distribution of the spot at the projecting point (it is represented by intensity of photodetection signal in the figure). The laser beam 9 normally has light intensity distribution similar to Gauss distribution with an optical axis of the so-called Gaussian beam as the center. As generally defined, in a spot diameter of a laser beam, boundary has light intensity which is 1/e² of the maximum value of the laser light intensity (=13.5%: the symbol e represents the base of natural logalithm). Accordingly, a spot diameter L is a diameter in which light intensity is 13.5% of the maximum value I₀.

When the laser beam 9 is projected to the surface of the substrate 2 for scanning, each laser beam 9 has a predetermined area at the projecting point and has light intensity distribution as described above. When the laser beam 9 is projected for scanning, the foreign matter or the like do not necessarily come across the center of the spot. Thus, the light amount of the scattered light differs between a case where the foreign matter or the like come across the center of the spot and a case where the foreign matter come across a point away from the center. In the past, the scanning pitch has been set in such manner that the scattered light is to be approximately 50% to 70% of that of the light when the matter come across the center of the spot, and a distance between the center of the spot and the point where the foreign matter or the like come across the projecting point of the laser beam has been determined.

FIG. 10 is a diagram showing a relation between light intensity distribution of the spot and the scanning pitch p. When light intensity obtained is at the minimum value, e.g. 60% of the maximum value of the light intensity distribution, the minimum value is at 0.25 L from the center of the maximum value (where L is a spot diameter). Therefore, the scanning pitch p is 0.5 L.

Detection sensitivity and detection accuracy are improved by increasing the intensity of the projected light, and the inspection time is shortened by increasing the scanning pitch. However, the spot has light intensity distribution similar to Gauss distribution as described above. When the scanning pitch is increased in order to shorten the inspection time, the light amount of the scattered light by the foreign matter detected near the end of the spot is decreased. As a result, detection accuracy may be decreased. There is a method to increase the rotating speed of the substrate 2 and to shorten the time of processing. However, when the rotating speed of the substrate 2 is increased, the detection accuracy is reduced, because, if the detection frequency in the photodetector is not changed, the number of the sampling point for detecting the scattered light is decreased. In case the detection frequency is increased, there may be such problem that influence of noise may increase. On the other hand, by high speed rotation, there is concern about generation of airflow and occurrence of dust from the rotary unit. Also, such change of design is required that the motor is replaced with a motor for high-speed rotation.

Further, a method is known to enlarge the shape of the spot only in a direction perpendicular to the scanning direction. However, when the power density of the projected light at the spot is decreased, there may be such a problem that the burden on the optical system may increase.

Also, when a laser diode is used as the light emitting source, the laser diode is disadvantageous in that the amount of emitted light is lower compared with a gas laser and the like despite of various other advantages. In this respect, there is limitation in the increase of the spot diameter by maintaining the light intensity of the projected light.

### SUMMARY OF THE INVENTION

It is an object of the present invention to provide a surface inspection apparatus using laser diodes as light emitting sources, by which it is possible to improve detection accuracy and to shorten the detection time.

To attain the above object, the present invention provides a surface inspection apparatus for detecting foreign matter and the like on a surface of a substrate by projecting and scanning laser beams to the surface of the substrate, comprising a light source unit for projecting two or more laser beams, and a projecting optical system for converging the laser beams so that the two or more laser beams are aligned in a row in a direction perpendicularly crossing the scanning direction at a projecting point on the substrate. Also, the present invention provides the surface inspection apparatus as described above, wherein each laser beam is superimposed on the adjacent laser beam at the projecting point on the surface of the substrate, and light intensity of the superimposed portion is approximately 50% or more with respect to the maximum value. Further, the present invention provides the surface inspection apparatus as described above, wherein the two or more laser beams are emitted from two or more light emitting sources. Also, the present invention provides the surface inspection apparatus as described above, wherein the two or more laser beams are obtained by splitting a laser beam emitted from a single light emitting source to two or more laser beams by an optical means. Further, the present invention provides the surface inspection apparatus as described above, wherein the two or more laser beams emitted from the two or more light emitting sources are guided by optical fibers respectively, and exit ends of the optical fibers are arranged in parallel to each other along a straight line. Also, the present invention provides the surface inspection apparatus as described above, wherein the exit ends of the optical fibers are arranged in two rows.

### BRIEF DESCRIPTION OF THE DRAWINGS

FIG. 1 is a schematical drawing of an embodiment of the present invention;

FIG. 2 is a schematical drawing of a light source unit to be used in the present embodiment;

FIG. 3 represents arrow diagrams as seen in a direction A of FIG. 2;

FIG. 4 is a drawing to show a shape of a spot at a projecting point on the embodiment;

FIG. 5 is a diagram showing light intensity distribution and scanning pitch of a spot at the projecting point in the embodiment;

FIG. 6 is a diagram showing a comparison of a spot width of a spot at the projecting point between the present invention and a conventional example;

FIG. 7 is a diagram showing a comparison of scanning pitch of a spot at the projecting point between the present invention and the conventional example;

FIG. 8 is a schematical drawing of a conventional example;

FIG. 9 is a diagram showing light intensity distribution of a spot at a projecting point in the conventional example; and

FIG. 10 is a diagram showing relation between light intensity distribution and scanning pitch in the conventional example.

### DETAILED DESCRIPTION OF THE PREFERRED EMBODIMENT

Description will be given below on an embodiment of the present invention referring to the drawings.

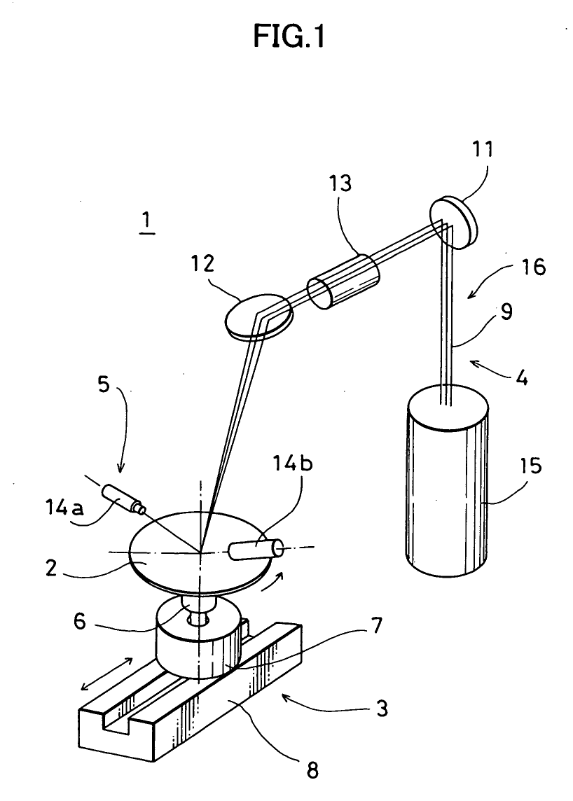

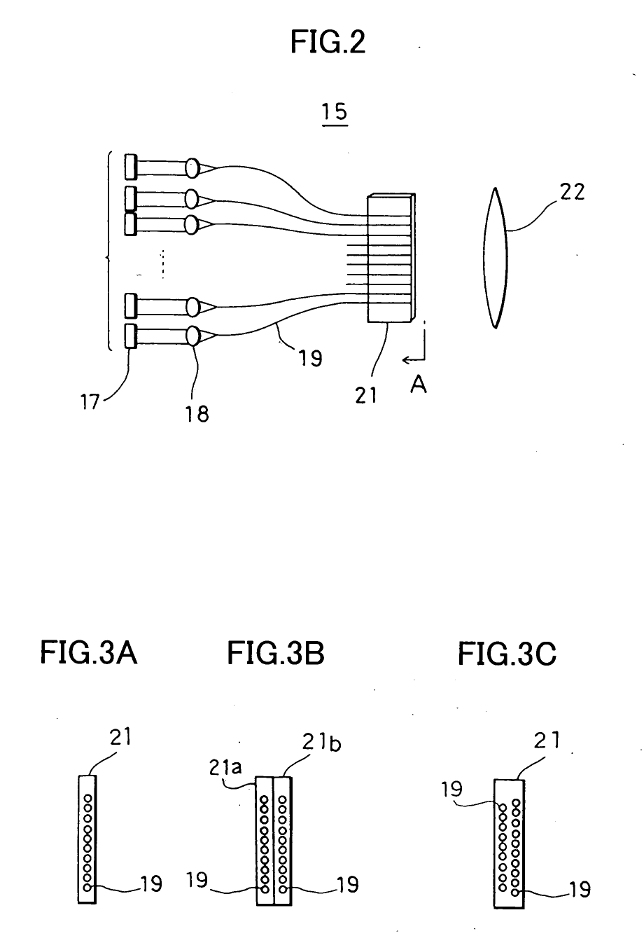

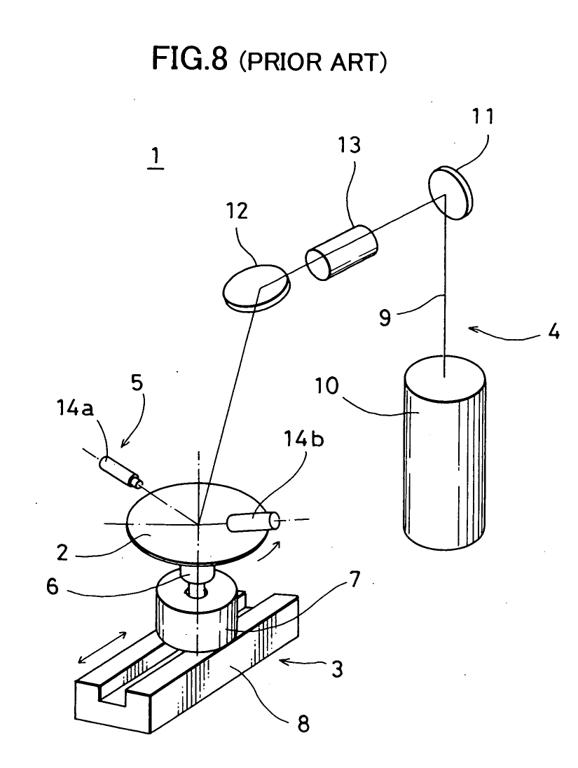

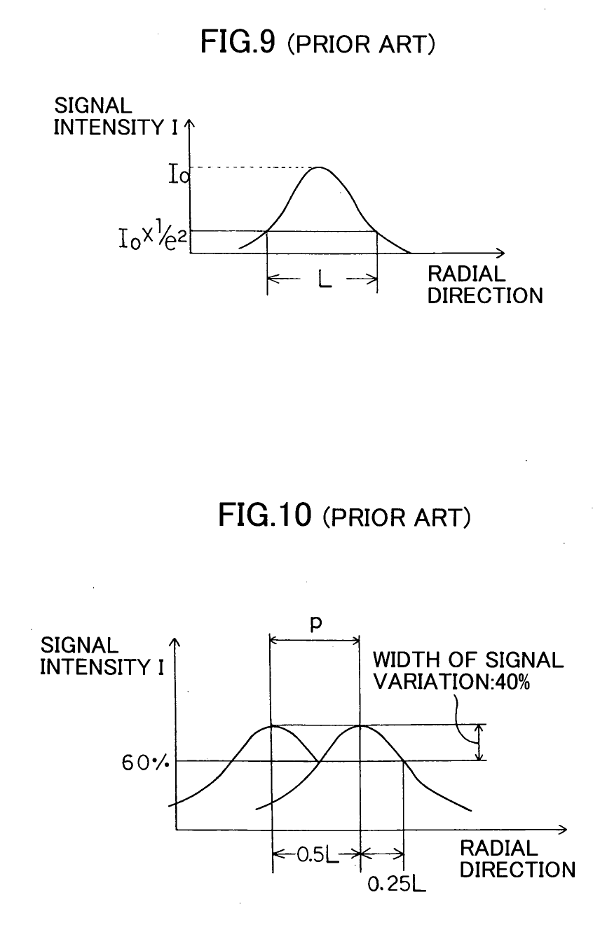

FIG. 1 and FIG. 2 each represents a schematical drawing of a surface inspection apparatus 1 according to the present invention and a light source unit 15 to be used in the surface inspection apparatus 1, and detailed description is not given here. In FIG. 1, the same component as shown in FIG. 8 is referred by the same symbol.

First, description will be given on general features of the surface inspection apparatus 1 referring to FIG. 1.

The surface inspection apparatus 1 primarily comprises a scan driving mechanism 3, a projecting optical system 4, and a detection system 5.

The scan driving mechanism 3 comprises a substrate holding unit 6 for holding a substrate 2. The substrate holding unit 6 is rotatably supported by a rotary driving unit 7. The rotary driving unit 7 is designed in such manner that the rotary driving unit 7 is linearly moved in a radial direction and in parallel to a rotating surface of the substrate 2 by a linear driving mechanism 8.

The projecting optical system 4 primarily comprises a light source unit 15, deflecting optical members 11 and 12 such as mirrors for deflecting a group of laser beams 16 emitted from the light source unit 15 onto the substrate 2, and a group of lenses 13 for converging the laser beam group 16 to the surface of the substrate 2. The detection system 5 comprises, for instance, two photodetectors 14a and 14b, and the photodetectors 14a and 14b receive scattered light reflected by the surface of the substrate 2. As the photodetectors 14a and 14b, photomultiplier tubes are used, for instance, and the scattered light thus received are converted by photoelectric conversion.

Next, description will be given on the light source unit 15 referring to FIG. 2 and FIG. 3.

The light source unit 15 comprises a predetermined number of light emitting sources, e.g. a predetermined number of laser diodes 17. To each of the laser diodes 17, a coupling lens 18 is provided, and to each coupling lens 18, an optical fiber 19 is arranged. An incident end surface of each optical fiber 19 is positioned coaxially with the coupling lens 18, and exit ends of the optical fibers 19 are held in parallel to each other with equal spacing between them along a straight line by a fiber holder 21. A condenser lens 22 is provided at a position to face to the fiber holder 21, and laser beams 9 projected from the optical fibers 19 are turned to parallel luminous fluxes. The exit end surfaces fulfill function as secondary light sources for projecting a plurality of laser beams 9, 9 . . . (the laser beam group 16).

FIG. 3(A), FIG. 3(B), and FIG. 3(C) each represents holding conditions of the optical fibers 19 at the fiber holder 21 when the optical fibers 19 are seen from a direction A of FIG. 2 respectively. FIG. 3(A) shows a case where the optical fibers 19 are held along a straight line with equal spacing between them. FIG. 3(B) shows a case where the fiber holders 21a and 21b shown in FIG. 3(A) are arranged in two rows superimposed on each other. The optical fibers 19 are arranged along a straight line with equal spacing and in two rows and in parallel to each other. In this case, the optical fibers may be arranged in such manner that, as shown in the figure, these are relatively facing to each other on the fiber holders 21a and 21b, or that the optical fibers are arranged alternately with the spacing between the optical fibers 19 deviated by one-half of the spacing (not shown). Further, FIG. 3(C) shows a case where the optical fibers 19 are arranged in a staggered arrangement (i.e., the optical fibers 19 are arranged in two rows and are deviated by half pitch between the two rows) and are integrated by the fiber holder 21.

The laser beam group 16 emitted from the light source unit 15 is deflected by the deflecting optical members 11 and 12 so as to be projected to the projecting point on the substrate 2. The laser beams 9 are converged by the lens group 13 so that a row where a part of the laser beams is superimposed is formed at the projecting point of the substrate 2.

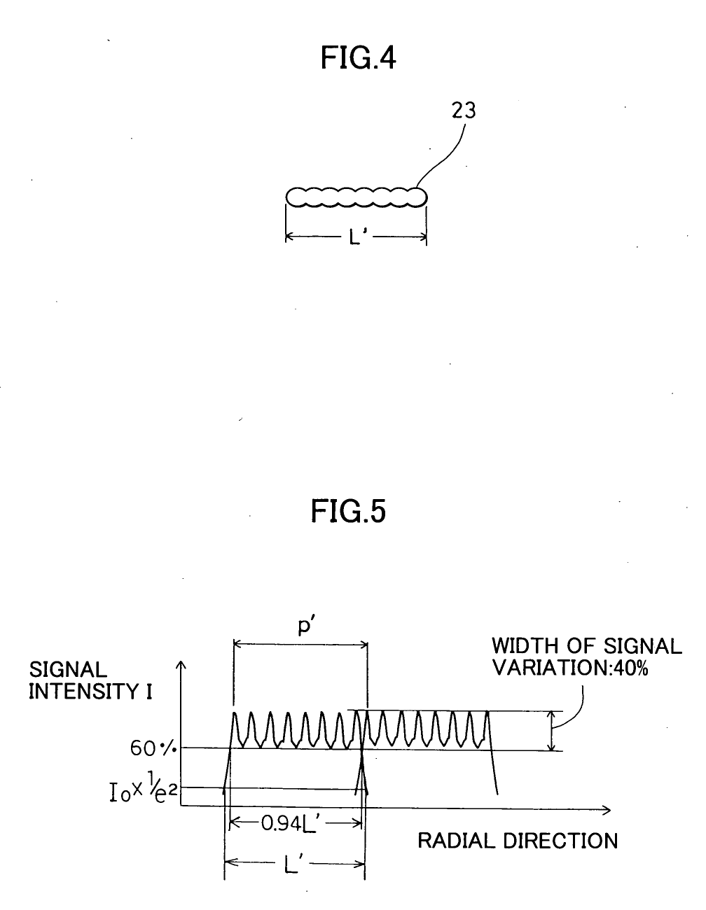

The laser beams 9 of the laser beam group 16 are partially superimposed on each other at the projecting point so that superimposing positions will be approximately more than 50% (for instance, more than 60%) of the maximum value of each laser beam 9. Therefore, a spot 23 of the laser beam group 16 projected to the projecting point has such a shape that it is in a state of a line segment having a constricted part at each superimposed position of the laser beams 9 as shown in FIG. 4. Light intensity distribution of the spot 23 is such that the maximum value is at the center of each of the laser beams 9 as shown in FIG. 5 and the minimum value is at the superimposed position. The difference between the maximum value and the minimum value is defined as a width of variation of the light intensity of the projected light. FIG. 5 represents light intensity distribution of the photodetection signal.

As shown in FIG. 5, when the laser beam group 16 is projected, scanning may be performed in superimposed manner with the scanning pitch p so that the spot 23 is approximately 50% or more (for instance, 60% or more) of the maximum value Io of the laser beam 9 at each end of the width.

Here, it is assumed that a length of the spot 23 formed by the laser beam group 16 in a direction perpendicular to the scanning direction is L′ (spot width: a width with a value of 13.5% of the maximum value of the light intensity).

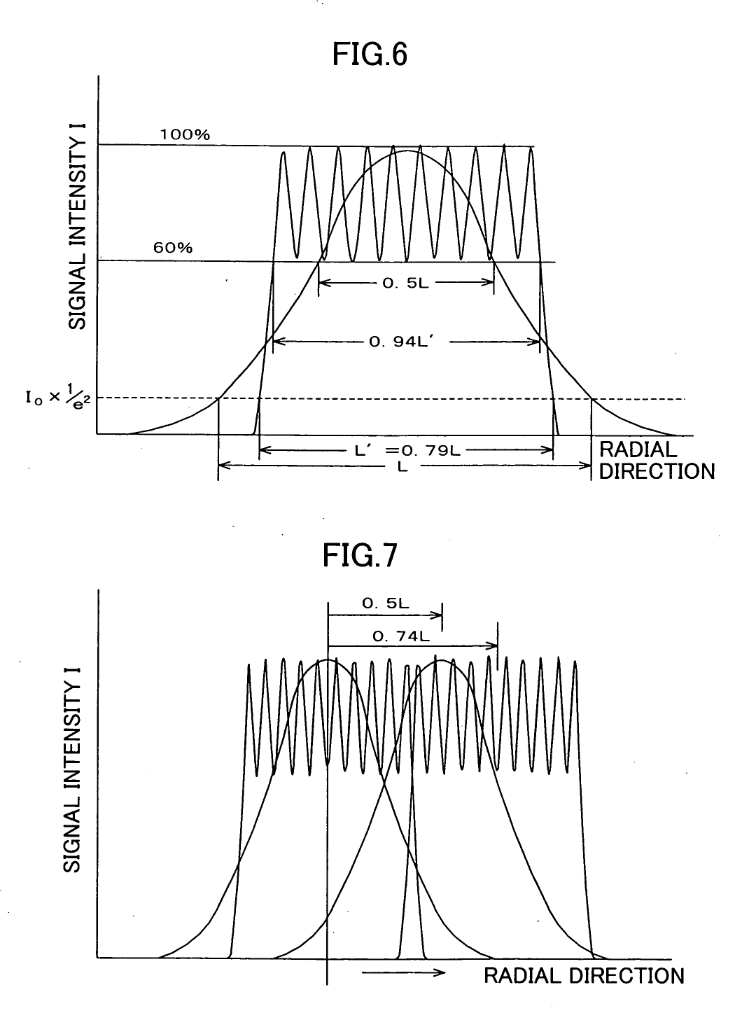

For instance, it is assumed that the number of the laser beams 9 of the laser beam group 16 is supposed to be 10. Here, the laser beam 9 has the same maximum value of light intensity as the laser beam with the spot diameter L which is used in the conventional example shown in FIG. 8, and the width of the laser beam 9 is one-tenth of the width of the conventional example. The laser beams 9 are arranged so that the superimposed portions have intensity values which is 60% of the maximum value. Thus, the laser beam group 16 are formed. Therefore, the spot width L′ of the laser beam group 16 is given as L′≈0.79 L with respect to the spot diameter L of the conventional example, as shown in FIG. 6.

Here, the projected light intensity is equivalent and the laser beams 9 are arranged so that the superimposed portions have intensity values which is 60% of the maximum value. Accordingly, there is no need to extensively change the setting of photodetectors for detecting scattered lights.

In the laser beam group 16, a range where approximately 50% or more (for instance, 60%) light intensity can be obtained with respect to the maximum value is given as 0.94 L′ with respect to the spot width L′, as shown in FIG. 6. Therefore, the scanning pitch P when scanning is performed by the laser beam group 16 is 0.94 L′. Further, when the projecting condition is set to the same projecting light intensity as the conventional example as described above, there exists a relationship of: L′=0.79 L. If a spot diameter is used as the standard when light is projected with the same projecting light intensity as in the conventional example, and if a single laser beam is projected, then the scanning pitch P is given as: P=0.5 L in case of the single laser beam, and P=0.94 L′=0.74 L in case of a group of laser beams.

Therefore, the spot width L′ of the projecting light in the present invention is smaller than the spot diameter L of the projected light in the conventional example, while the spot width is 0.74 L when light intensity is about 60% of the maximum value in light intensity distribution.

Here, it is assumed that the scanning pitch P is 0.74 L. Then, the intensity of the photodetection signal when foreign matter or the like come across the spot 23 is in the range of 60% to 100%. Thus, surface inspection can be carried out with a pitch of 0.74 L without reducing the light amount of the scattered light although surface inspection must be performed with the scanning pitch of 0.5 L in the conventional case.

In the surface inspection of the substrate 2, the laser beam group 16 is projected to the surface of the substrate 2 by the projecting optical system 4 under such condition that the substrate 2 is rotated by the rotary driving unit 7. Further, the rotary driving unit 7 is moved in the radial direction by the linear driving mechanism 8 so that the scanning pitch will be 0.74 L.

The scattered lights are detected by the photodetectors 14a and 14b, and the photodetectors 14a and 14bissue electric signals after photoelectric conversion. Signal processing such as analysis is performed on the signals from the photodetectors 14a and 14b by an arithmetic processor (not shown), and number and size of foreign matter, flaws, etc. are detected.

In the surface inspection apparatus 1 as described above, scanning pitch varies according to a combination of rotating speed of the substrate 2 and feeding speed of the linear driving mechanism 8. Therefore, if the rotating speed of the substrate 2 is set to a constant value, inspection time is shortened if the scanning pitch is increased. If the scanning pitch is decreased, inspection time will be longer. Further, the light amount of the scattered light depends on the size of the foreign matter and on light intensity of the projected laser beam. That is, in general, the higher the light intensity is, the more the light intensity of the scattered light increases, and the larger the foreign matter are, the higher the light amount of the scattered light is.

As described above, when the number of the laser beams 9 of the laser beam group 16 is set to 10, scanning can be performed with a scanning pitch of 0.74 L. Thus, the scanning pitch can be extensively increased in comparison with the scanning pitch of 0.5 L, i.e. the scanning pitch when Gaussian beam with the equivalent spot diameter is used (See FIG. 7), and the time required for surface inspection can be extensively reduced. It goes without saying that various adjustments can be made on the spot width L′ by selecting the number of the laser diodes 17 or by changing magnifying power of the projecting optical system 4.

In the above embodiment, a plurality of laser diodes 17 are used, while it may be designed in such manner that a single laser diode 17 is used, and the beam is split to a plurality of laser beams 9′ by means of an optical system, e.g. diffraction optical element, and the laser beam group 16 may be made up by these laser beams 9′.

The present invention provides a surface inspection apparatus for detecting foreign matter and the like on a surface of a substrate by projecting and scanning laser beams to the surface of the substrate, comprising a light source unit for projecting two or more laser beams, and a projecting optical system for converging the laser beams so that the two or more laser beams are aligned in a row in a direction perpendicularly crossing the scanning direction at a projecting point on the substrate. As a result, pitch of the projecting spot in a direction perpendicularly crossing the scanning direction is increased. This makes it possible to increase the scanning pitch and to shorten the inspection time.

What is claimed is:

1. A surface inspection apparatus for detecting foreign matter and the like on a surface of a substrate by projecting and scanning laser beams to the surface of the substrate, comprising a light source unit for projecting two or more laser beams, and a projecting optical system for converging the laser beams so that the two or more laser beams are aligned in a row in a direction perpendicularly crossing the scanning direction at a projecting point on the substrate.

2. A surface inspection apparatus according to claim 1, wherein each laser beam is superimposed on the adjacent laser beam at the projecting point on the surface of the substrate, and light intensity of the superimposed portion is approximately 50% or more with respect to the maximum value.

3. A surface inspection apparatus according to claim 1, wherein said two or more laser beams are emitted from two or more light emitting sources.

4. A surface inspection apparatus according to claim 1, wherein said two or more laser beams are obtained by splitting a laser beam emitted from a single light emitting source to two or more laser beams by an optical means.

5. A surface inspection apparatus according to claim 3, wherein said two or more laser beams emitted from said two or more light emitting sources are guided by optical fibers respectively, and exit ends of the optical fibers are arranged in parallel to each other along a straight line.

6. A surface inspection apparatus according to claim 5, wherein the exit ends of the optical fibers are arranged in two rows.
